(19) United States
(12) Patent Application Publication
(10) Pub. No.: US 2015/0359210 A1
(43) Pub. Date: Dec. 17, 2015

(54) Fishing Rod Holder Device

(71) Applicants: John Rossi, Vacaville, CA (US); Amy Rossi, Vacaville, CA (US)

(72) Inventors: John Rossi, Vacaville, CA (US); Amy Rossi, Vacaville, CA (US)

(21) Appl. No.: 14/303,756

(22) Filed: Jun. 13, 2014

(51) Int. Cl. A01K 97/10; B63B 25/00; B63B 17/00

(52) U.S. Cl. CPC A01K 97/10; B63B 17/00; B63B 25/002

(57) ABSTRACT

A fishing rod holder device keeps fishing poles organized, stable and safe during transportation of the fishing poles. The device includes a first mount and a second mount each mounted to a gunwale of a boat. A first holder is pivotally coupled to the first mount and has an aperture positioned therein for receiving a handle of a fishing pole. A second holder is pivotally coupled to the second mount. The second holder has an opening positioned therein that is alignable with the aperture for receiving a tip of the fishing pole.

### BACKGROUND OF THE DISCLOSURE

### Field of the Disclosure

The disclosure relates to article holding devices and more particularly pertains to a new article holding device for keeping fishing poles organized, stable and safe during transportation of the fishing poles.

### SUMMARY OF THE DISCLOSURE

An embodiment of the disclosure meets the needs presented above by generally comprising a first mount and a second mount each mounted to a gunwale of a boat. A first holder is pivotally coupled to the first mount and has an aperture positioned therein for receiving a handle of a fishing pole. A second holder is pivotally coupled to the second mount. The second holder has an opening positioned therein that is alignable with the aperture for receiving a tip of the fishing pole.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a fishing rod holder device according to an embodiment of the disclosure.

FIG. 2 is a front view of an embodiment of the disclosure.

FIG. 3 is a rear view of an embodiment of the disclosure.

FIG. 4 is a bottom view of an embodiment of the disclosure.

FIG. 5 is an in-use perspective view of an embodiment of the disclosure.

### DESCRIPTION OF THE PREFERRED EMBODIMENT

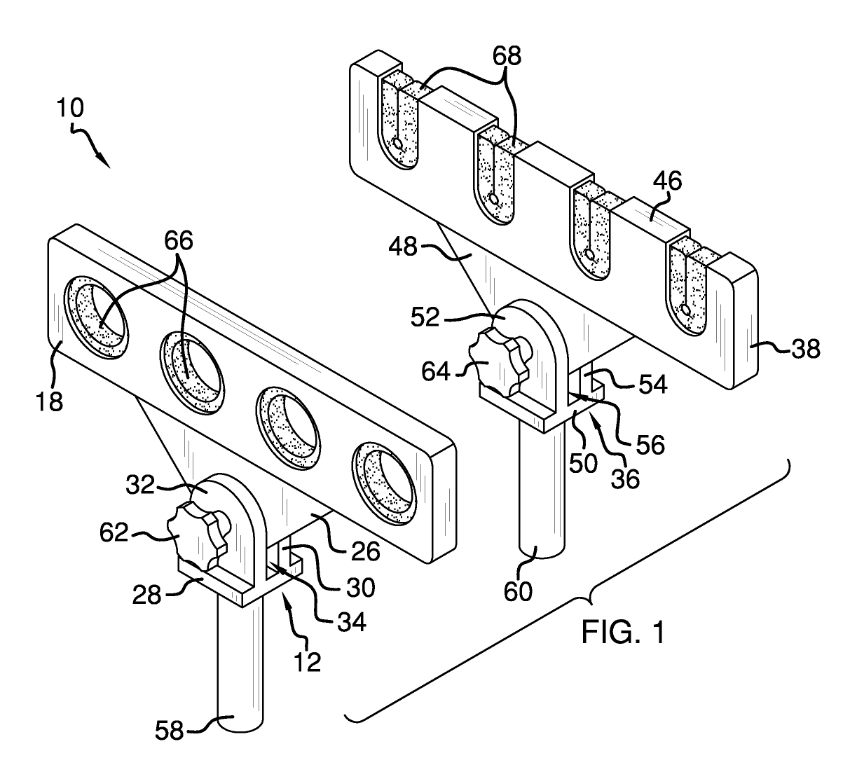

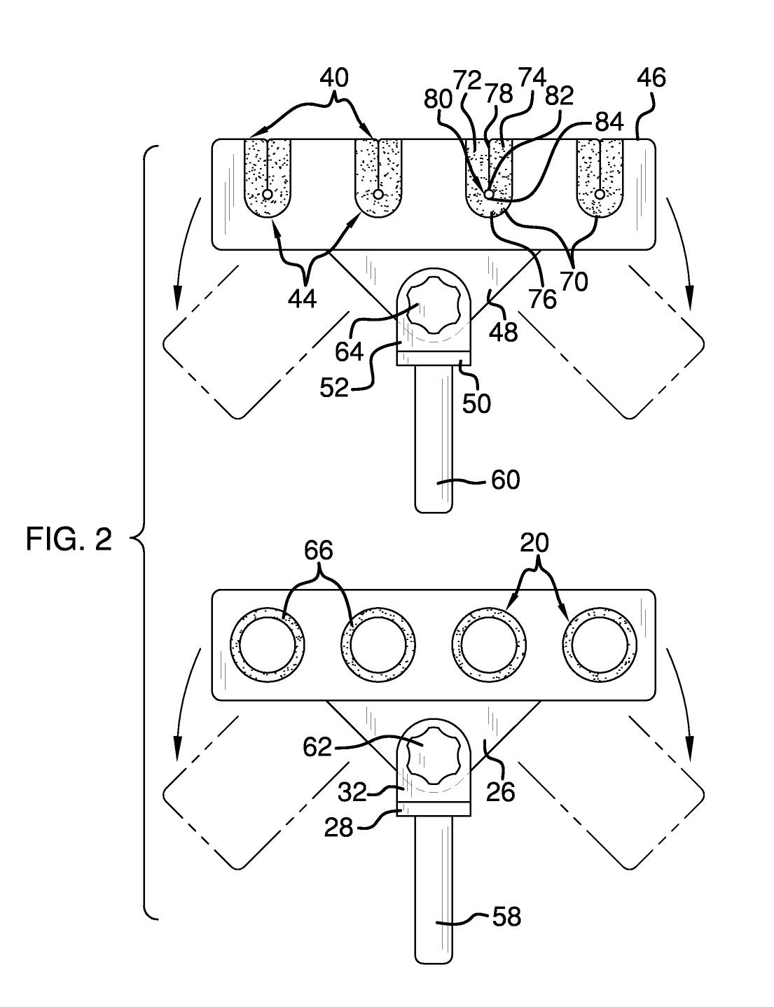

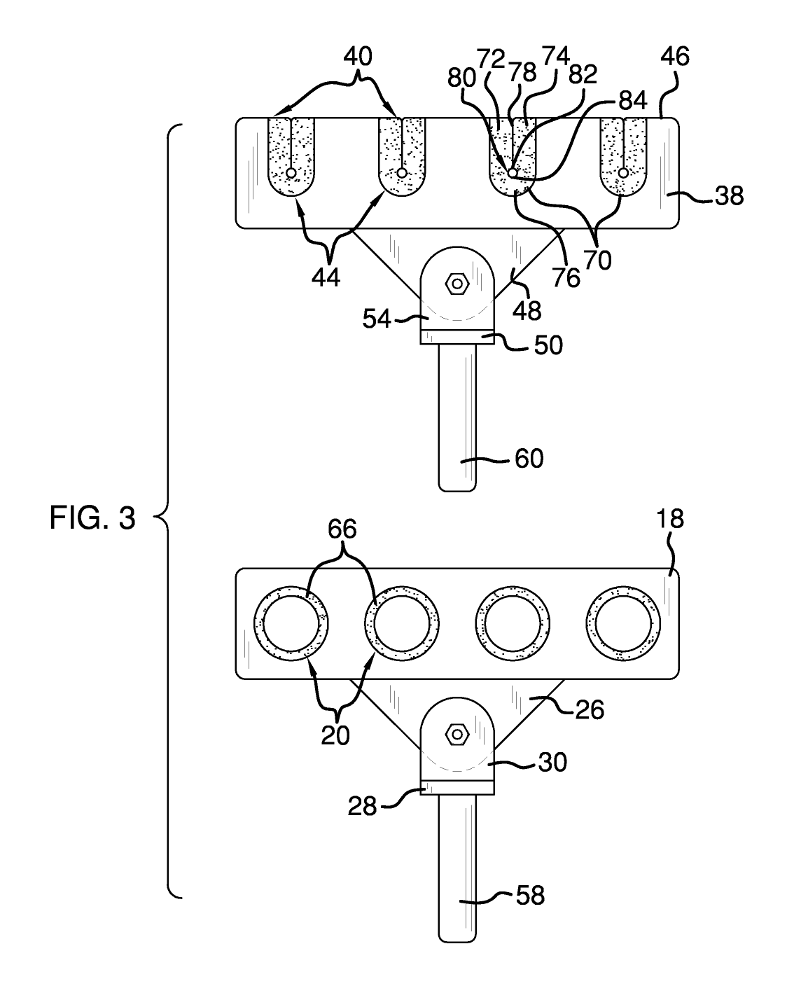

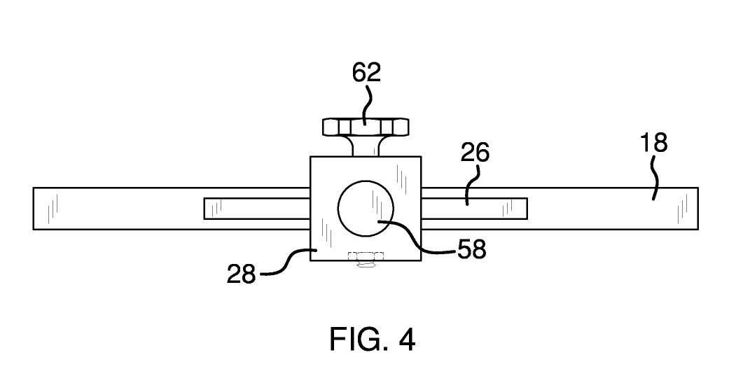

With reference now to the drawings, and in particular to FIGS. 1 through 5 thereof, a new article holding device embodying the principles and concepts of an embodiment of the disclosure and generally designated by the reference numeral 10 will be described.

As best illustrated in FIGS. 1 through 5, the fishing rod holder device 10 generally comprises a first mount 12 configured for being mounted to a gunwale 14 of a boat 16. A first holder 18 is pivotally coupled to the first mount 12. The first holder 18 has an aperture 20 positioned therein configured for receiving a handle 22 of a fishing pole 24. A first plate 26 pivotally couples the first holder 18 to the first mount 12. The first mount 12 includes a base wall 28 and a pair of side walls 30, 32 coupled to and extending upwardly from the base wall 28. The side walls 30, 32 are spaced from each other defining a receiving space 34 therebetween for receiving the first plate 26 therein.

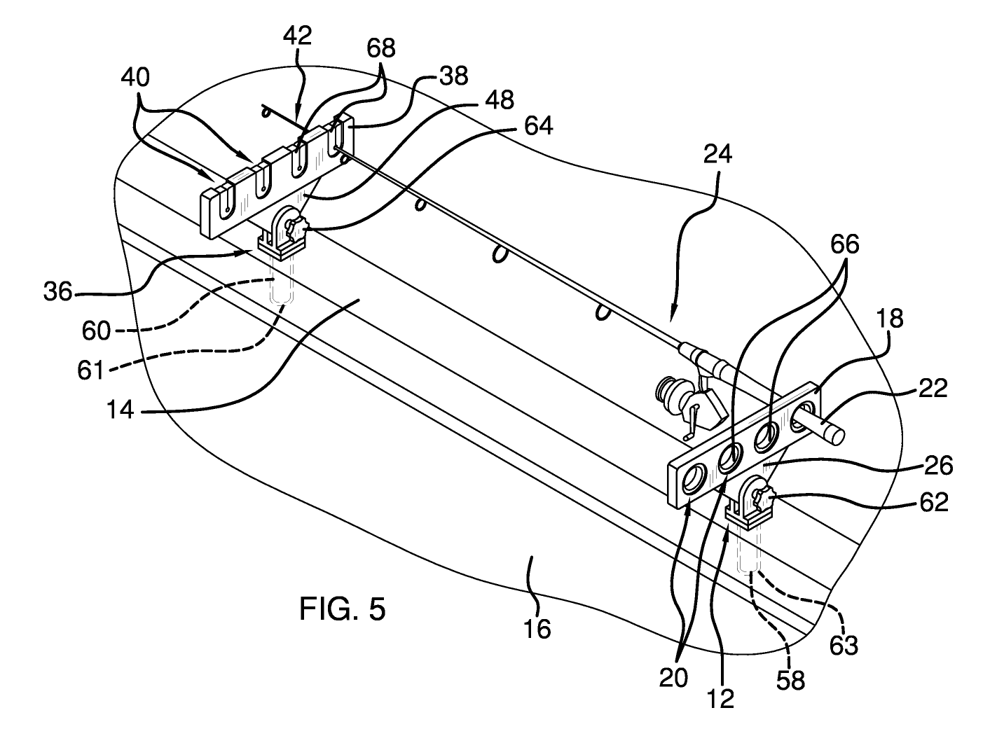

A second mount 36 is provided and is also configured for being mounted to the gunwale 14 of the boat 16. The second mount 36 may be positioned relative to the first mount 12 so that the fishing pole 24 extends lengthwise along the boat 16, as shown in FIG. 5, or alternatively, may be positioned so that the fishing pole 24 extends across a width of the boat 16. The second holder 38 is pivotally coupled to the second mount 36. The second holder 38 has an opening 40 positioned therein that is alignable with the aperture 20 for receiving a tip 42 of the fishing pole 24. The opening 40 may comprise a slot 44, which may be arcuate, extending into a top side 46 of the second holder 38. A second plate 48 pivotally couples the second holder 38 to the second mount 36. The second mount 36 includes a lower wall 50 and a pair of upper walls 52, 54 coupled to and extending upwardly from the lower wall 50. The upper walls 52, 54 are spaced from each other defining a gap 56 therebetween for receiving the second plate 48 therein.

Each of the base wall 28 and the lower wall 50 has a respective shaft 58, 60 attached thereto and extending downwardly therefrom. Each of the shafts 58, 60 is configured to extend into a respective sleeve 61, 63 coupled to the gunwale 14 of the boat 16. Each of the first 12 and second 36 mounts has a respective knob 62, 64 attached thereto wherein manipulating the knob 62 of the first mount 12 permits locking the first holder 18 at a selectable angle relative to the first mount 12 and manipulating the knob 64 of the second mount 36 permits locking the second holder 38 at a selectable angle relative to the second mount 36.

Each of the aperture 20 and the opening 40 has a cushioning material 66, 68, which may comprise foam or a similar elastomer, positioned therein for protecting the fishing pole 24 when the fishing pole 24 is positioned in the associated aperture 20 and opening 40. The cushioning material 68 in the slot 44 abuts a peripheral edge 70 of the slot 44 and includes a pair of arms 72, 74 and a medial section 76 coupled to and extending between the pair of arms 72, 74. The arms 72, 74 may abut each other to ensure that the fishing pole 24 is securely retained in the opening 40. The arms 72, 74 are unattached to each other defining a slit 78 therebetween. The slit 78 terminates in a hole 80 positioned between a bottom end 82 of the slit 78 and a top end 84 of the medial section 76. The hole 80 is configured to receive the tip 42 of the fishing pole 24. Other than the cushioning material 66, 68, the features of the device 10 are constructed from a rigid material, such as plastic, metal or the like.

To accommodate a greater number of fishing poles 24, the aperture 20 may be one of a plurality of aligned apertures 20 positioned in the first holder 18. Similarly, the opening 40 may be one of a plurality of aligned openings 40 positioned in the second holder 38. Each of the openings 40 is alignable with a corresponding one of the apertures 20 for supporting the tip 42 and handle 22 of each fishing pole 24. Although only four apertures 20 and four openings 40 are shown in the Figures, it should be understood that a greater number of apertures 20 and openings 40 may be provided.

In use, each shaft 58, 60 is inserted into the respective sleeve 61, 63 for attaching the first 12 and second 36 mounts to the gunwale 14 of a boat 16. The first 12 and second 36 mounts are aligned relative to each other so that the openings 40 and the apertures 20 are also aligned. The first 18 and second 38 mounts are pivoted to a desired position and locked into place using the knobs 62, 64. Fishing poles 24 are then supported thereon by inserting the handle 22 of each fishing pole 24 into an associated aperture 20 and the tip 42 of each fishing pole 24 into a corresponding opening 40. In this manner, the device 10 prevents damage to and stabilizes fishing poles 24 during transport.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing rod holder device comprising:
a first mount configured for being mounted to a gunwale of a boat;
a first holder pivotally coupled to said first mount, said first holder having an aperture positioned therein configured for receiving a handle of a fishing pole;
a second mount configured for being mounted to the gunwale of the boat; and
a second holder pivotally coupled to said second mount, said second holder having an opening positioned therein being alignable with said aperture for receiving a tip of the fishing pole.

2. The device of claim 1, further comprising:
said aperture being one of a plurality of aligned said apertures positioned in said first holder; and
said opening being one of a plurality of aligned said openings positioned in said second holder, each of said openings being alignable with a corresponding one of said apertures.

3. The device of claim 1, further comprising said opening comprising a slot extending into a top side of said second holder.

4. The device of claim 3, further comprising wherein said slot is arcuate.

5. The device of claim 3, further comprising each of said aperture and said opening having a cushioning material positioned therein for protecting the fishing pole when the fishing pole is positioned in said associated aperture and said opening.

6. The device of claim 5, further comprising wherein said cushioning material in said slot abuts a peripheral edge of said slot, said cushioning material in said slot including a pair of arms and a medial section coupled to and extending between said pair of arms, said arms being unattached to each other defining a slit therebetween.

7. The device of claim 6, further comprising said slit terminating in a hole positioned between a bottom end of said slit and a top end of said medial section, said hole being configured to receive the tip of the fishing pole.

8. The device of claim 1, further comprising:
a first plate pivotally coupling said first holder to said first mount; and
a second plate pivotally coupling said second holder to said second mount.

9. The device of claim 8, further comprising:
said first mount including a base wall and a pair of side walls coupled to and extending upwardly from said base wall, said side walls being spaced from each other defining a receiving space therebetween for receiving said first plate therein; and
said second mount including a lower wall and a pair of upper walls coupled to and extending upwardly from said lower wall, said upper walls being spaced from each other defining a gap therebetween for receiving said second plate therein.

10. The device of claim 1, further comprising each of said first and second mounts having a respective knob attached thereto wherein manipulating said knob of said first mount permits locking said first holder at a selectable angle relative to said first mount and manipulating said knob of said second mount permits locking said second holder at a selectable angle relative to said second mount.

11. The device of claim 1, further comprising each of said first mount and said second mount having a respective shaft attached thereto and extending downwardly therefrom, each of said shafts being configured to extend into a respective sleeve coupled to the gunwale of the boat.

12. The device of claim 9, further comprising each of said base wall and said lower wall having a respective shaft attached thereto and extending downwardly therefrom, each of said shafts being configured to extend into the gunwale of the boat.

13. The device of claim 6, further comprising said arms abutting each other.

14. A fishing rod holder device comprising:
a first mount configured for being mounted to a gunwale of a boat;
a first holder pivotally coupled to said first mount, said first holder having an aperture positioned therein configured for receiving a handle of a fishing pole;
a first plate pivotally coupling said first holder to said first mount, said first mount including a base wall and a pair of side walls coupled to and extending upwardly from said base wall, said side walls being spaced from each other defining a receiving space therebetween for receiving said first plate therein;
a second mount configured for being mounted to the gunwale of the boat;
a second holder pivotally coupled to said second mount, said second holder having an opening positioned therein being alignable with said aperture for receiving a tip of the fishing pole, said opening comprising a slot extending into a top side of said second holder, said slot being arcuate;
a second plate pivotally coupling said second holder to said second mount, said second mount including a lower wall and a pair of upper walls coupled to and extending upwardly from said lower wall, said upper walls being spaced from each other defining a gap therebetween for receiving said second plate therein;
each of said first and second mounts having a respective knob attached thereto wherein manipulating said knob of said first mount permits locking said first holder at a selectable angle relative to said first mount and manipulating said knob of said second mount permits locking said second holder at a selectable angle relative to said second mount;
each of said base wall and said lower wall having a respective shaft attached thereto and extending downwardly therefrom, each of said shafts being configured to extend into a respective sleeve coupled to the gunwale of the boat;
each of said aperture and said opening having a cushioning material positioned therein for protecting the fishing pole when the fishing pole is positioned in said associated aperture and said opening, said cushioning material in said slot abutting a peripheral edge of said slot, said cushioning material in said slot including a pair of arms and a medial section coupled to and extending between said pair of arms, said arms being unattached to each other defining a slit therebetween, said arms abutting each other, said slit terminating in a hole positioned between a bottom end of said slit and a top end of said medial section, said hole being configured to receive the tip of the fishing pole;
wherein said aperture is one of a plurality of aligned said apertures positioned in said first holder; and
wherein said opening is one of a plurality of aligned said openings positioned in said second holder, each of said openings being alignable with a corresponding one of said apertures.
